(19) United States
(12) Patent Application Publication
(10) Pub. No.: US 2026/0056698 A1
(43) Pub. Date: Feb. 26, 2026

(54) AUDIO OUTPUT DEVICE AND METHOD FOR CONTROLING AUDIO OUTPUT DEVICE

(71) Applicant: ICOM INCORPORATED, Osaka (JP)

(72) Inventors: Satoshi MATSUDA, Osaka (JP); Tatsuo FURUKAWA, Osaka (JP); Masanori KITABATA, Osaka (JP)

(21) Appl. No.: 19/303,728

(22) Filed: Aug. 19, 2025

(30) Foreign Application Priority Data
Aug. 23, 2024 (JP) 2024-143466

(51) Int. Cl. G06F 3/16

(52) U.S. Cl. CPC G06F 3/162

(57) ABSTRACT

To provide an audio output device and the like each of which is capable of reducing, with a simple configuration, a possibility of causing a trouble such as interruption and/or skipping of audio, the audio output device includes: a communication section receiving audio data from an audio transmitting device; a ring buffer in which the audio data received by the communication section is temporarily stored; an audio processing section obtaining the audio data from the ring buffer and carrying out an audio process on the audio data to output audio; an oscillator outputting a clock signal specifying operation of the audio processing section; and a clock control section controlling a frequency of the clock signal according to a remaining level of the ring buffer.

### CROSS-REFERENCE TO RELATED APPLICATIONS

This Nonprovisional application claims priority under 35 U.S.C. § 119 on Patent Application No. 2024-143466 filed in Japan on Aug. 23, 2024, the entire contents of which are hereby incorporated by reference.

### TECHNICAL FIELD

The present invention relates to: an audio output device included in a radio device capable of dealing with a high frequency signal; and the like.

### BACKGROUND ART

In a radio device or the like, transmission and reception of packetized audio data is carried out between (i) a controller which is operated by a user and (ii) a radio processing device which controls transmission and reception. Each of the controller and the radio processing device includes an oscillator for a clock. In order to sequentially reproduce received audio data, the clocks of these two devices need to be in synchronization with each other. The reason for this is as follows. That is, if the clocks deviate from each other, there may occur a disadvantageous phenomenon, for example, (i) jumping of audio caused by overflow of the audio data from a buffer or (ii) interruption of audio caused by a phenomenon that reception of the audio data cannot catch up reproduction speed of the audio.

In order to deal with this, for example, Patent Literature 1 discloses a communication system including an adjustment means which is a device on a reception side and which measures, by using clocks of its own oscillation circuit, an interval between received packets and adjusts a frequency Of its own oscillation circuit so that the measurement result has a constant interval.

### CITATION LIST

### Patent Literature

### Patent Literature 1

Japanese Patent Application Publication, Tokukai, No. 2024-83706

### SUMMARY OF INVENTION

### Technical Problem

As discussed above, Patent Literature 1 discloses a method for counting clocks while a given amount of packets are received. However, in a case where communication between devices is carried out by using only a general-purpose CPU without using an FPGA or a DSP, counting of clocks is substantially impossible. Thus, in order to use the general-purpose CPU, an additional means for counting clocks should be provided. That is, separately from the one for general communication process, a dedicated signal processing circuit, which is expensive, should be prepared. This makes the device complicated, and also leads to increase in cost.

An aspect of the present invention was made in light of the above problem, and has an object to provide an audio output device and the like that can reduce, with a simple configuration, a possibility of causing a trouble such as interruption of audio and/or skipping of audio.

### Solution to Problem

In order to attain the above object, an audio output device in accordance with an aspect of the present invention is an audio output device which is communicably connected with an audio transmitting device transmitting audio data, which receives the audio data from the audio transmitting device, and which outputs audio according to the audio data, the audio output device including: a communication section which receives the audio data from the audio transmitting device; a buffer in which the audio data received by the communication section is temporarily stored; an audio processing section which obtains the audio data from the buffer and carries out an audio process with respect to the audio data so as to output audio; an oscillator which outputs a clock signal specifying operation of the audio processing section; and a clock control section which controls a frequency of the clock signal according to a remaining level of the buffer.

A method, in accordance with an aspect of the present invention, for controlling an audio output device is a method for controlling an audio output device which is communicably connected with an audio transmitting device transmitting audio data, which receives the audio data from the audio transmitting device, and which outputs audio according to the audio data, the method including: a communication step of receiving the audio data from the audio transmitting device; an audio processing step of obtaining the audio data from a buffer in which the audio data received in the communication step is temporarily stored and carrying out an audio process with respect to the audio data so as to output audio; and a clock control step of controlling, according to a remaining level of the buffer, a frequency of a clock signal specifying operation of the audio processing step.

### Advantageous Effects of Invention

In accordance with an aspect of the present invention, it is possible to adjust a frequency of a clock signal that appropriately specifies operation of the audio processing section according to a remaining level of the buffer. Thus, it is possible to provide an audio output device that can reduce, with a simple configuration and without causing increase in cost of the device, a possibility of causing a trouble such as interruption of audio and/or skipping of audio.

### BRIEF DESCRIPTION OF DRAWINGS

FIG. 1 is a view illustrating an example of a radio device in accordance with an embodiment of the present invention.

FIG. 2 is a functional block diagram illustrating a configuration of a main part of an audio output device included in the radio device.

FIG. 3 is a view for explaining an example of a control process of a clock control section in the audio output device.

FIG. 4 is a view for explaining an example of a control process of the clock control section in the audio output device.

FIG. 5 is a view for explaining a method for calculating a remaining level of a ring buffer.

FIG. 6 is a flowchart illustrating a flow of a process carried out by the audio output device.

FIG. 7 is a flowchart illustrating a flow of a process carried out by the audio output device.

### DESCRIPTION OF EMBODIMENTS

### Overview of Radio Device 1

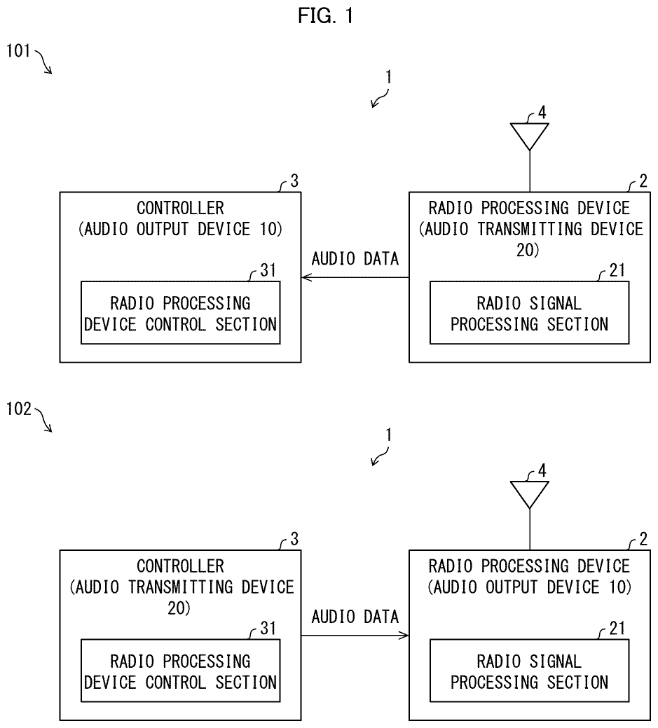

The following description will discuss details of an embodiment of the present invention. FIG. 1 is a view schematically illustrating an overview of a radio device 1 in accordance with the present embodiment. The radio device 1 is a radio device which can be used in a frequency band which is, for example, an HF band or a VHF band. As shown in FIG. 1, the radio device 1 includes a radio processing device 2, a controller 3 which is operated by a user, and an antenna 4. The radio processing device 2 includes an antenna terminal (not illustrated) for radio communication, and is connected with the antenna 4 via, e.g., a coaxial cable. The radio processing device 2 and the controller 3 are communicably connected with each other via, e.g., a LAN cable.

In FIG. 1, “101″ shows an example of a case where a radio signal is received by the radio device 1. That is, the radio processing device 2 functions as the later-described audio transmitting device 20, and the controller 3 functions as the later-described audio output device 10. In FIG. 1, ”102″ shows an example of a case where a radio signal is transmitted by the radio device 1. That is, the radio processing device 2 functions as the audio output device 10, and the controller 3 functions as the audio transmitting device 20. FIG. 1 illustrates a case where each of the radio processing device 2 and the controller 3 independently controls a frequency of a clock. Alternatively, only the controller 3 may control a frequency of a clock. That is, the later-described clock control section 14 may be included only in the controller 3, and the controller 3 may control a frequency of a clock for each of transmission and reception of a radio signal.

The radio processing device 2 includes a radio signal processing section 21 which processes a high frequency signal transmitted or received by the antenna 4.

The controller 3 includes a radio processing device control section 31 which controls operation of the radio processing device 2.

A process relating to reception and transmission of a radio signal carried out by the radio device 1 can be carried out by a known technique. Therefore, a detailed configuration and an explanation thereof is not presented here. The following is a simple explanation thereof.

For example, reception of a radio signal is carried out as follows. That is, the radio signal is received by the antenna 4. Thereafter, in the radio signal processing device 21 of the radio processing device 2, the radio signal is subjected to processes such as filtering and conversion into an intermediate frequency signal, and then is subjected to analog-to-digital conversion so as to be converted into a received digital signal. Then, the received digital signal is subjected to a digital operating process so as to be decoded, so that audio data which is digital data is generated. The audio data thus generated is transmitted to the controller 3 via, e.g., a LAN cable. Upon reception of the audio data, the controller 3 carries out a digital operating process so as to decode the audio data into an analog signal, and carries out digital-to analog conversion with respect to the decoded audio signal, so as to convert the decoded audio signal into an analog signal. Then, the controller 3 amplifies the analog signal, and thereafter outputs the analog signal via, e.g., a speaker.

Note that, in transmission and reception of audio data, the radio processing device 2 uses a clock which is based on an oscillator provided to the radio processing device 2, and the controller 3 uses a clock which is based on an oscillator provided to the controller 3.

In transmission of a radio signal, a process reverse to the above is carried out. That is, when audio is input via, e.g., a microphone of the controller 3, an audio signal is subjected to conversion so that an analog signal is converted into a digital signal, a digital operating process is carried out with respect to the digital signal, so that audio data which is digital data is generated. The audio data thus generated is transmitted to the radio processing device 2 via a LAN cable. Thereafter, in the radio processing device 2, the audio data is subjected to a digital operating process so as to be modulated into a high frequency signal, and the high frequency signal is transmitted via the antenna 4.

### Details of Audio Output Device 10

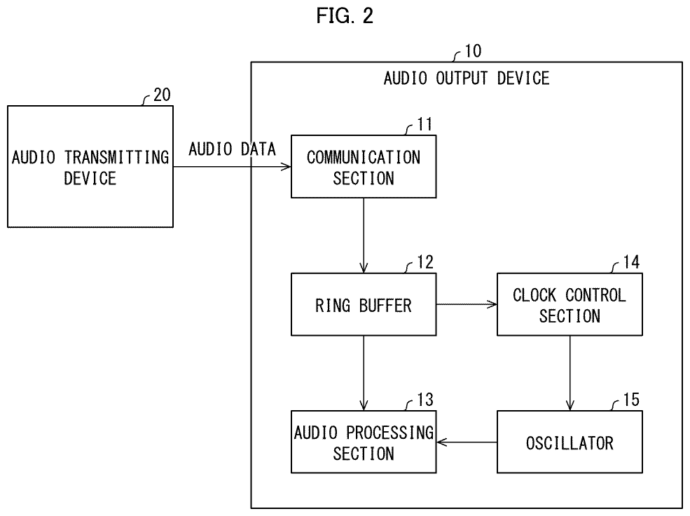

Next, the following description will discuss, with reference to FIG. 2, details of the audio output device 10. FIG. 2 is a functional block diagram illustrating a configuration of a main part of the audio output device 10. The audio output device 10 herein refers to a device which is on a side receiving audio data in transmission and reception of the audio data carried out between the radio processing device 2 and the controller 3 in the radio device 1. That is, in a case where the radio device 1 receives a radio signal, the controller 3 serves as the audio output device 10. Meanwhile, in a case where the radio device 1 transmits a radio signal, the radio processing device 2 serves as the audio output device 10. Note that the device which is on a side transmitting audio data will be referred to as the audio transmitting device 20.

In other words, in a case where the controller 3 serves as the audio output device 10, it can be said that the audio transmitting device 20 serves as the radio processing device 2 which processes a high frequency signal transmitted or received by the antenna 4. Further, it can be said that the audio output device 10 further includes the radio processing device control section 10 which controls operation of the radio processing device 20.

In a case where the radio processing device 2 serves as the audio output device 10, it can be said that the audio output device 10 further includes the radio signal processing section 21 which processes a high frequency signal transmitted or received by the antenna 4. Further, it can be said that the audio transmitting device 20 serves as the controller 3 which controls operation of the audio output device 10 serving as the radio processing device 2.

As shown in FIG. 2, the audio output device 10 includes a communication section 11, a ring buffer (buffer) 12, an audio processing section 13, a clock control section 14, and an oscillator 15.

The communication section 11 receives audio data from the audio transmitting device 20. To be more specific, the communication section 11 receives, in streaming, the audio data from the audio transmitting device 20.

The ring buffer 12 is a buffer in which the audio data received by the communication section 11 is temporarily stored.

The audio processing section 13 obtains the audio data from the ring buffer 12. Then, the audio processing section 13 carries out a digital operating process and/or the like with respect to the audio data, and outputs audio. The communication section 11 receives, in streaming, the audio data from the audio transmitting device 20, and the audio processing section 13 can output, in real time, the audio data received by the communication section 11. The audio processing section 13 is configured to operate according to a clock which is based on the later-described oscillator 15. In other words, operation of the audio processing section 13 is specified by a clock of the oscillator 15.

The clock control section 14 is configured to control, according to a remaining level of the ring buffer 12, an oscillation frequency of the oscillator 15. Examples of the control method include control carried out according to an analog voltage value and a pulse width modulation (PWM) control. Note that details of the clock control section 14 will be given later.

The oscillator 15 is an oscillator including a vibrator and an oscillator circuit which can be controlled according to a voltage. Examples of the oscillator include a Voltage Controlled X'tal Oscillator (VCXO), a Voltage Controlled Temperature Compensated X'tal Oscillator (VC-TCXO), and a Voltage Controlled Oven Controlled X'tal Oscillator (VC-OCXO).

### Details of Clock Control Section 14

As discussed above, the audio transmitting device 20 transmits audio data according to a clock which is based on the oscillator provided to the audio transmitting device 20, and the audio output device 10 processes the received audio data according to a clock which is based on the oscillator provided to the audio output device 10. Thus, if the clock of the audio transmitting device 20 and the clock of the audio output device 10 deviate from each other, there occurs a trouble such as jumping of audio and/or interruption of audio.

In order to deal with this, the clock control section 14 controls, according to a remaining level of the ring buffer 12, a frequency (oscillation frequency) of a clock which is based on the oscillator 15. To be more specific, in a case where the remaining level of the ring buffer 12 reaches an upper limit or a lower limit of a given range, the clock control section 14 calculates, on the basis of a time period taken for the remaining level of the ring buffer 12 to change from an ordinal remaining level value to the upper limit or the lower limit, an amount of expected deviation from an appropriate value for the frequency of the clock in this time period. Then, the clock control section 14 controls the oscillation frequency of the oscillator 15 so as to reduce the amount of the expected deviation thus calculated. By carrying out the control so as to reduce the amount of the expected deviation according to the remaining level of the ring buffer 12, it is possible to absorb the deviation between the clock of the audio transmitting device 20 and the clock of the audio output device 10.

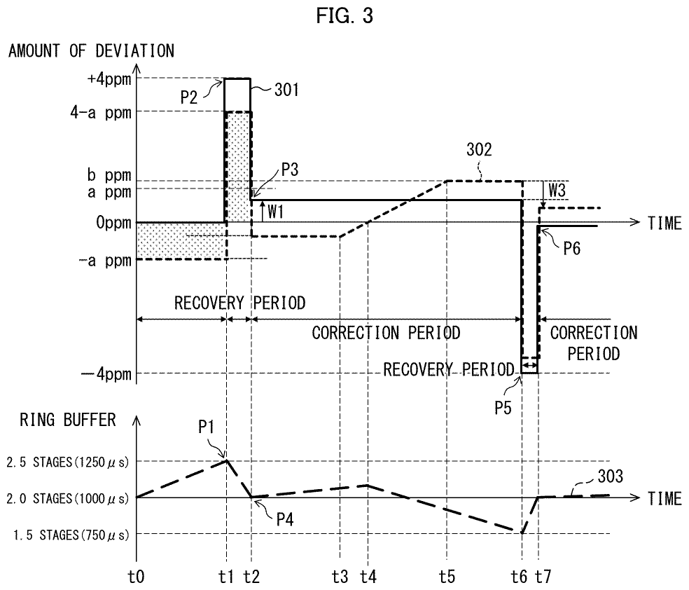

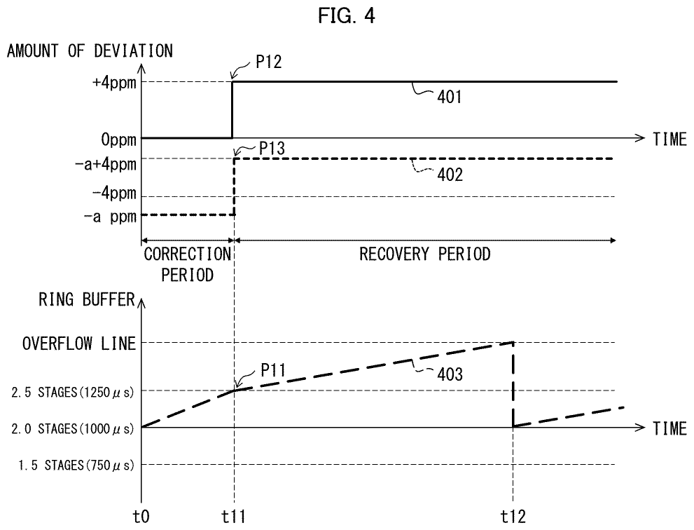

The following description will discuss, with reference to FIGS. 3 and 4, an example of a process carried out by the clock control section 14. Each of FIGS. 3 and 4 illustrates a relation between (i) a remaining level of the ring buffer 12, (ii) an amount of actual deviation between a clock of the audio output device 10 and a clock of the audio transmitting device 20, and (iii) an amount by which a frequency of the clock of the audio output device 10 is adjusted by the clock control section 14.

In FIG. 3, a solid line 301 indicates an amount by which a clock is adjusted by the clock control section 14, a broken line 302 indicates an amount of actual deviation between a clock of the audio output device 10 and a clock of the audio transmitting device 20, and a broken line 303 indicates a remaining level of the ring buffer 12.

An amount of deviation between clocks is calculated by using a remaining level of the ring buffer 12. The clock control section 14 measures a remaining level of the ring buffer 12 every second, for example. Then, for example, if the remaining level of the ring buffer 12 increases by 250 μs in 100 seconds, it is assumed that deviation of 250 has occurred in 100 seconds and an amount of the deviation is calculated as 250 μs/100 seconds=2.5 ppm (parts per million).

In the example shown in FIG. 3, in the ring buffer 12, a single stage has 500 μs. Further, an ordinal remaining level value of the ring buffer 12 is 1000 μs (two stages), an upper limit of the ring buffer 12 is 1250 μs (2.5 stages), and a lower limit of the ring buffer 12 is 750 μs (1.5 stages). Details of the number of stages indicative of the remaining level of the ring buffer 12 will be given later.

FIG. 3 illustrates a case where an amount of deviation at a time point t0 is −a (ppm). That is, this case corresponds to a state where the clock of the audio output device 10 is lower by a (ppm) than that of the audio transmitting device 20. Here, the amount of the deviation a (ppm) indicates a degree to which a frequency of the oscillator 15 is deviated from a target frequency, the degree being expressed by a proportion in parts per million. Further, as described above, the amount of the deviation a (ppm) can be calculated by using a fact that it took t seconds for deviation of 250 μs to occur (a =250 μs/t).

In the example shown in FIG. 3, at a time point t1, the remaining level of the ring buffer 12 reaches 1250 μs, which is the upper limit (P1). At this point, the clock control section 14 adjusts the frequency of the clock by a sufficiently large given amount so that the remaining level of the ring buffer 12 decreases. Given that the adjustment amount, serving as the given amount, for the clock at the time point t0 is 0 ppm, the adjustment is carried out so that the frequency of the clock becomes higher by 4 ppm (P2). Note that the given amount may be a maximum value of an adjustment range for the frequency of the oscillator 15. In this example, the given amount is 4 ppm, which is a maximum value for the oscillator 15, for example. A period in which the amount of the deviation is corrected by adjusting the frequency of the clock by the given amount may be called a “recovery period”.

Thereafter, when the remaining level of the ring buffer 12 changes back to the ordinal remaining level value (1000 μs) at the time point t2, the clock control section 14 corrects the amount of the deviation by a given proportion with respect to the deviation amount a (ppm) observed at the time point t0 (P3). Here, for example, the predetermined proportion is two-thirds, and an amount of deviation to be kept is one-third of a (ppm). In this case, a correction amount is (W1=a*2/3), and an amount of deviation to be kept is a*1/3 (ppm). A period in which the clock is adjusted by a predetermined proportion with respect to the amount of the deviation at the time point t0 may be called a “correction period”.

In the case illustrated in FIG. 3, at the time point t2, the deviation between the clocks is corrected; thereafter, in a period from the time point t3 to the time point t5, due to a factor such as a temperature change, deviation for making the clock of the audio output device 10 higher occurs. In the example illustrated in FIG. 3, in the period from the time point t3 to the time point t5, the clock becomes higher; and at the time point t5, the clock of the audio output device 10 is higher by b (ppm) than that of the audio transmitting device 20. Further, at the time point t4, the state where the clock of the audio output device 10 is lower than that of the audio transmitting device 20 is changed to a state where the clock of the audio output device 10 is higher than that of the audio transmitting device 20. At this time, with the lapse of time, a state where the remaining level of the ring buffer 12 increases is changed to a state where the remaining level of the ring buffer 12 decreases.

Then, when the time passes in this state and, at the time point t0, the remaining level of the ring buffer 12 reaches the lower limit, i.e., 750 μs, the clock control section 14 adjusts the frequency of the clock by the given amount so that the remaining level of the ring buffer 12 increases. That is, given that the adjustment amount, serving as the given amount, for the clock at the time point t0 is 0 ppm, the adjustment is carried out so that the frequency of the clock becomes lower by 4 ppm (P5).

Thereafter, when the remaining level of the ring buffer 12 changes back to the ordinal remaining level value (1000 μs) at the time point t7, the clock control section 14 corrects the amount of the deviation by a given proportion with respect to b (ppm) (P6). That is, a correction amount is (W3=b*2/3), and an amount of deviation to be kept is b*1/3 (ppm). Thereafter, according to the remaining level of the ring buffer 12, the same process is carried out repeatedly.

As discussed above, in a case where the remaining level of the ring buffer 12 reaches the upper limit of the given range, the clock control section 14 makes the frequency of the clock of the oscillator 15 higher by a sufficiently large given amount (ppm). Thereafter, at the time that the remaining level of the ring buffer 12 changes back to the ordinal remaining level value, the clock control section 14 controls the frequency so as to reduce the amount of the expected deviation. Meanwhile, in a case where the remaining level of the ring buffer 12 reaches the lower limit of the given range, the clock control section 14 makes the frequency of the clock lower by a given amount (ppm); thereafter, at the time that the remaining level of the ring buffer 12 changes back to the ordinal remaining level value, the clock control section 14 controls the frequency so as to reduce the amount of the expected deviation. Thus, at the timing that the remaining level of the ring buffer 12 reaches the upper limit or the lower limit of the given range, the frequency of the clock is adjusted. This can shorten a time period taken for the remaining level of the ring buffer 12 to change back to the ordinal remaining level value. Consequently, it is possible to prevent or reduce occurrence of overflow or exhaustion of the ring buffer 12.

In a case where the remaining level of the ring buffer 12 reaches the upper limit of the given range, the clock control section 14 makes the frequency higher by a sufficiently large given amount (ppm). Thereafter, at the time that the remaining level of the ring buffer 12 changes back to the ordinal remaining level value, the clock control section 14 makes the frequency higher, by a value obtained by reducing an amount of expected deviation by a given proportion (e.g., two-thirds), than a frequency observed at a timing immediately before the remaining level of the ring buffer 12 reaches the upper limit of the given range. Similarly, in a case where the remaining level of the ring buffer 12 reaches the lower limit of the given range, the clock control section 14 makes the frequency lower by a given amount (ppm). Thereafter, at the time that the remaining level of the ring buffer changes back to the ordinal remaining level value, the clock control section 14 makes the frequency lower, by a value obtained by reducing an amount of expected deviation by a given proportion, than a frequency observed at a timing immediately before the remaining level of the ring buffer 12 reaches the lower limit of the given range. Thus, the frequency is adjusted with a value obtained by reducing an amount of expected deviation by a given proportion. Therefore, it is possible to prevent or reduce a phenomenon that the frequency is changed more than necessary and consequently is varied drastically.

The example illustrated in FIG. 4 shows a case where deviation could not be absorbed even by carrying out adjustment as much as possible (by a given amount) so that an amount of deviation decreases. That is, this case corresponds to a case where the amount of the deviation a (ppm) is not less than 4 ppm. In FIG. 4, a solid line 401 indicates an amount by which a clock is adjusted by the clock control section 14, a broken line 402 indicates an amount of actual deviation between a clock of the audio output device 10 and a clock of the audio transmitting device 20, and a broken line 403 indicates a remaining level of the ring buffer 12.

In this case, as shown in FIG. 4, at a time point t11, a remaining the ring buffer 12 reaches 1250 μs, which is the upper limit (P11). At this point, the clock control section 14 adjusts the frequency of the clock by a sufficiently large given amount so that the remaining level of the ring buffer 12 decreases (P12). Consequently, the amount of the deviation between the clock of the audio transmitting device 20 and the clock of the audio output device 10 becomes (−a+4) ppm (P13). However, the deviation is not absorbed completely so that the remaining level of the ring buffer 12 decreases. Therefore, the remaining level of the ring buffer 12 gradually increases, and, at a time point t12, overflow from the remaining level 12 occurs. In this case, audio data would be deleted until the remaining level of the ring buffer 12 reaches the ordinal remaining level value (1000 μs). Consequently, in this case, jumping of audio occurs. However, this can elongate a time period until occurrence of audio jumping and accordingly can reduce a frequency of occurrence of jumping of audio, as compared to a case where the adjustment is not carried out.

In a case where the amount of the deviation between the clocks is 4 ppm, it takes 62.5 seconds (=250/4) for the remaining level of the ring buffer 12 to increase by 250 μs, and therefore, if the time point t11 is shorter than 62.5 seconds, the deviation between the clocks cannot be absorbed with the adjustment of the frequency for the given amount.

### Number of Stages Indicative of Remaining Level of Ring Buffer 12

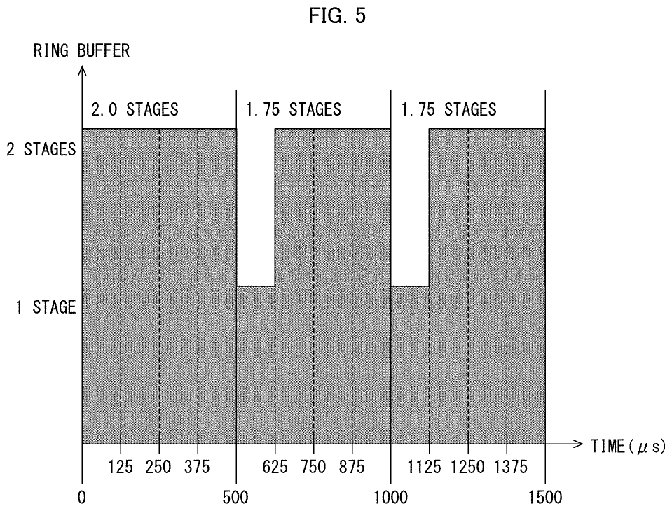

Next, the following description will discuss, with reference to FIG. 5, the number of stages indicative of a remaining level of the ring buffer 12. In the ring buffer 12, audio data is stored in units of 500 μs. That is, a single stage is constituted by 500 μs. However, if the number of stages of the ring buffer 12 is checked at every 500 μs, the number of stages becomes rough. In particular, when the remaining level decreases, the number of stages is two (1000 μs) or one (500 μs). Thus, when a frequency of a clock signal based on the oscillator 15 is adjusted according to the number of stages of the remaining level of the ring buffer 12, a degree of the adjustment is rough. In order to deal with this, in the present embodiment, the number of stages of the ring buffer 12 is checked at every 125 μs, and an average is calculated at every 500 μs. The average at every 500 μs may be calculated for a longer period. For example, as illustrated in FIG. 5, in a case where the number of stages is two at the time point of 125 μs, the number of stages is two at the time point of 250 μs, the number of stages is two at the time point of 375 μs, and the number of stages is two at the time point of 500 μs, the number of stages at 500 μs would be two. Subsequently, in a case where the number of stages at the time point of 625 μs is one, the number of stages at the time point of 750 μs is two, the number of stages at the time point of 875 μs is two, and the number of stages at the time point of 1000 μs is two, the number of stages at 1000 μs would be 1.75. The same applies to the subsequent time points. Thus, the number of stages of the ring buffer 12 is calculated in units of 0.25 stages (125 μs). With this, a degree of adjustment for a frequency of the oscillator 15 carried out according to the number of stages of the remaining level of the ring buffer 12 can be made finer.

### Flow of Process of Audio Output Device 10

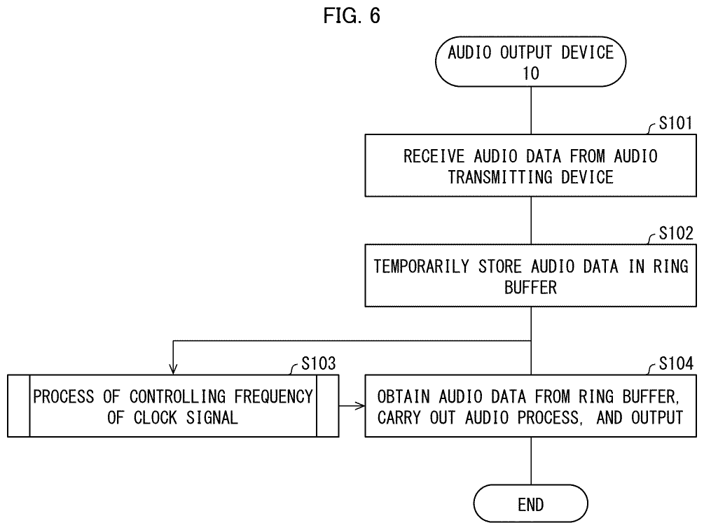

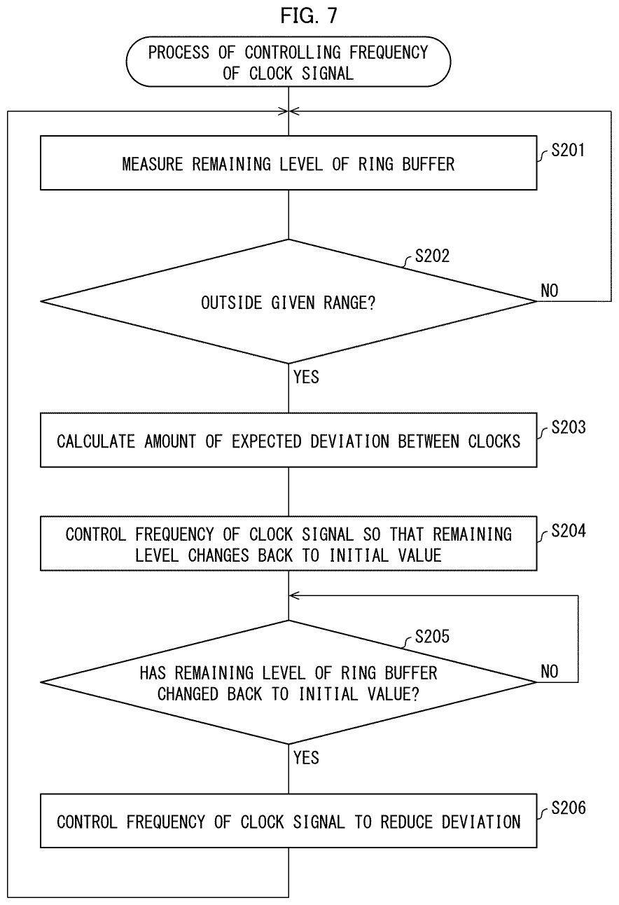

Next, the following description will discuss, with reference to FIGS. 6 and 7, a flow of a process carried out by the audio output device 10. FIGS. 6 and 7 show a flowchart illustrating a flow of a process carried out by the audio output device 10.

As shown in FIG. 6, in the audio output device 10, first, the communication section 11 receives audio data from the audio transmitting device 20 (S101, communication step). The audio data received by the communication section 11 is temporarily stored in the ring buffer 12 (S102). According to a remaining level of the ring buffer 12, the clock control section 14 carries out a process of controlling a frequency of a clock of the oscillator 15 (S103, clock control step). The audio processing section 13 obtains the audio data from the ring buffer 12, and carries out, according to the clock of the oscillator 15, an audio process with respect to the audio data so as to output audio data (S104, audio processing step).

Details of the process of the control for the frequency of the clock, carried out by the clock control section 14, in step S103 are as described below. The clock control section 14 measures a remaining level of the ring buffer 12 at given time intervals (S201). For example, the clock control section 14 measures a remaining level of the ring buffer 12 at every second. As discussed above, the audio data is processed in units of 500 μs. Therefore, in a case where the measurement is carried out at every second, an average of “500 μs×remaining levels of 2000 ring buffers 12” is obtained as a remaining level of the ring buffer 12 at every second.

Then, the clock control section 14 determines whether or not the remaining level of the ring buffer 12 goes outside the given range (S202). In other words, the clock control section 14 determines whether the remaining level of the ring buffer 12 is above the upper limit or below the lower limit. If the remaining level of the ring buffer 12 goes outside the given range (YES in S202), the clock control section 14 calculates an amount of deviation between the clock of the audio output device 10 and the clock of the audio transmitting device 20 (S203). Then, the clock control section 14 controls the frequency of the oscillator 15 so that the remaining level of the ring buffer 12 changes back to the initial value (S204). Thereafter, if the remaining level of the ring buffer 12 changes back to an initial value (YES in S205), the clock control section 14 adjusts the frequency of the oscillator 15 so as to reduce the deviation between the clocks (S206). The amount of the adjustment is a value obtained by the calculated deviation between the clocks by a given proportion. Thereafter, the procedure returns to step S201, and the same process is repeated.

The flow of the process carried out by the audio output device 10 is as discussed above.

### Software Implementation Example

The functions of the audio output device 10 (hereinafter, referred to as “device”) can be realized by a program for causing a computer to function as the device, the program causing the computer to function as the control blocks (in particular, the audio processing section 13 and the clock control section 14) of the device.

In this case, the device includes a computer that has at least one control device (for example, a processor) and at least one storage device (for example, a memory) as hardware for executing the program. The control device and the storage device execute the program, so as to realize the functions described in the above embodiments.

The program can be stored in one or more non-transitory computer-readable storage media. The storage medium can be provided in the device, or the storage medium does not need to be provided in the device. In the latter case, the program can be supplied to the device via any wired or wireless transmission medium.

Some of B all of the functions of the control blocks can be realized by a logic circuit. For example, the present invention encompasses, in its scope, an integrated circuit (including a Field-Programmable Gate Array (FPGA) and a Digital Signal Processor (DSP) ) in which a logic circuit that functions as each of the above-described control blocks is formed. In addition, the function of each of the control blocks can be realized by, for example, a quantum computer.

The processes described in the above embodiments may be carried out by artificial intelligence (AI). In this case, AI may be operated in the control device, or may be operated in another device (e.g., an edge computer or a cloud server).

Aspects of the present invention can also be expressed as follows:

An audio output device in accordance with a first aspect of the present invention is an audio output device which is communicably connected with an audio transmitting device transmitting audio data, which receives the audio data from the audio transmitting device, and which outputs audio according to the audio data, the audio output device including: a communication section which receives the audio data from the audio transmitting device; a buffer in which the audio data received by the communication section is temporarily stored; an audio processing section which obtains the audio data from the buffer and carries out an audio process with respect to the audio data so as to output audio; an oscillator which outputs a clock signal specifying operation of the audio processing section; and a clock control section which controls a frequency of the clock signal according to a remaining level of the buffer. With the above configuration, it is possible to adjust the frequency of the clock signal which appropriately specifies operation of the audio processing section according to the remaining level of the buffer. Therefore, it is possible to provide an audio output device which can prevent a trouble such as interruption of audio and/or skipping of audio without causing increase in cost of the device.

An audio output device in accordance with a second aspect of the present invention is configured such that, in the first aspect, the communication section receives, in streaming, the audio data from the audio transmitting device; and the audio processing section outputs the audio data as audio in real time. With the above configuration, the audio data received in streaming can be output as audio in real time, without causing a trouble such as interruption of audio and/or skipping of audio.

An audio output device in accordance with a third aspect of the present invention is configured such that, in the first or second aspect, in a case where the remaining level of the buffer reaches an upper limit or a lower limit of a given range, the clock control section calculates, on a basis of a time period taken for the remaining level of the buffer to change from an ordinal remaining level value to the upper limit or the lower limit, an amount of expected deviation from an appropriate value for a frequency of the clock signal in this time period, and the clock control section controls the frequency of the clock signal so as to reduce the amount of the expected deviation. With the above configuration, the frequency of the clock signal is controlled so as to reduce the amount of the expected deviation obtained on the basis of the time period taken for the remaining level of the buffer to change from the ordinal remaining level value to the upper limit or the lower limit. Therefore, it is possible to more appropriately execute the control for the frequency of the clock signal.

An audio output device in accordance with a fourth aspect of the present invention is configured such that, in the third aspect, in a case where the remaining level of the buffer reaches the upper limit of the given range, the clock control section makes the frequency of the clock signal higher by a given adjustment amount, and, thereafter, at a time that the remaining level of the buffer changes back to the ordinal remaining level value, the clock control section controls the frequency of the clock signal so as to reduce the amount of the expected deviation; and in a case where the remaining level of the buffer reaches the lower limit of the given range, the clock control section makes the frequency of the clock signal lower by a given adjustment amount, and, thereafter, at a time that the remaining level of the buffer changes back to the ordinal remaining level value, the clock control section controls the frequency of the clock signal so as to reduce the amount of the expected deviation. With the above configuration, at a timing that the remaining level of the buffer reaches the upper limit or the lower limit of the given range, the frequency of the clock signal is adjusted with a given adjustment amount. Therefore, it is possible to shorten a time period taken for the remaining level of the buffer to change back to the ordinal remaining level value. Consequently, it is possible to prevent or reduce occurrence of overflow or exhaustion of the buffer.

An audio output device in accordance with a fifth aspect of the present invention is configured such that, in the fourth aspect, in a case where the remaining level of the buffer reaches the upper limit of the given range, the clock control section makes the frequency of the clock signal higher by a given adjustment amount, and, thereafter, at a time that the remaining level of the buffer changes back to the ordinal remaining level value, the clock control section makes the frequency of the clock signal higher, by a value obtained by reducing the amount of the expected deviation by a given proportion, than a frequency of the clock signal observed at a timing immediately before the remaining level of the buffer reaches the upper limit of the given range; and in a case where the remaining level of the buffer reaches the lower limit of the given range, the clock control section makes the frequency of the clock signal lower by a given adjustment amount, and, thereafter, at a time that the remaining level of the buffer changes back to the ordinal remaining level value, the clock control section makes the frequency of the clock signal lower, by a value obtained by reducing the amount of the expected deviation by a given proportion, than a frequency Of the clock signal observed at a timing immediately before the remaining level of the buffer reaches the lower limit of the given range. With the above configuration, after the frequency of the clock signal is adjusted with a given adjustment amount, the frequency of the clock signal is adjusted with the value obtained by reducing the amount of the expected deviation by a given proportion. Therefore, it is possible to prevent or reduce a phenomenon that the frequency of the clock signal is changed more than necessary and consequently is varied drastically.

An audio output device in accordance with a sixth aspect of the present invention is configured such that, in any one of the first to fifth aspects, the audio transmitting device is a radio processing device which processes a high frequency signal transmitted or received by an antenna; and the audio output device further includes a radio processing device control section which controls operation of the radio processing device. With the above configuration, it is possible to provide a controller of the radio processing device capable of outputting, without causing a trouble such as interruption of audio and/or skipping of audio, the audio signal received by the radio processing device.

An audio output device in accordance with a seventh aspect of the present invention is configured such that, in any one of the first to fifth aspects, the audio output device further includes: a radio signal processing section which processes a high frequency signal transmitted or received by an antenna, wherein the audio transmitting device is a controller which controls operation of the audio output device serving as a radio processing device. With the above configuration, it is possible to provide the radio processing device capable of outputting, without causing a trouble such as interruption of audio and/or skipping of audio, the audio signal received from the controller.

A method, in accordance with an eighth aspect of the present invention, for controlling an audio output device is a method for controlling an audio output device which is communicably connected with an audio transmitting device transmitting audio data, which receives the audio data from the audio transmitting device, and which outputs audio according to the audio data, the method including: a communication step of receiving the audio data from the audio transmitting device; an audio processing step of obtaining the audio data from a buffer in which the audio data received in the communication step is temporarily stored and carrying out an audio process with respect to the audio data so as to output audio; and a clock control step of controlling, according to a remaining level of the buffer, a frequency of a clock signal specifying operation of the audio processing step.

The audio output device in accordance with the foregoing aspects of the present invention may be realized by a computer. In such a case, the present invention encompasses: a control program for the audio output device which program causes a computer to operate as each section (software element) of the audio output device so that the audio output device can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: radio device
2: radio processing device
21: radio signal processing section
3: controller
31: radio processing device control section
4: antenna
10: audio output device
11: communication section
12: ring buffer (buffer)
13: audio processing section
14: clock control section
15: oscillator
20: audio transmitting device

1. An audio output device which is communicably connected with an audio transmitting device transmitting audio data, which receives the audio data from the audio transmitting device, and which outputs audio according to the audio data, the audio output device comprising:
a communication section which receives the audio data from the audio transmitting device;
a buffer in which the audio data received by the communication section is temporarily stored;
an audio processing section which obtains the audio data from the buffer and carries out an audio process with respect to the audio data so as to output audio;
an oscillator which outputs a clock signal specifying operation of the audio processing section; and
a clock control section which controls a frequency of the clock signal according to a remaining level of the buffer.

2. The audio output device according to claim 1, wherein:
the communication section receives, in streaming, the audio data from the audio transmitting device; and
the audio processing section outputs the audio data as audio in real time.

3. The audio output device according to claim 1, wherein:
in a case where the remaining level of the buffer reaches an upper limit or a lower limit of a given range, the clock control section calculates, on a basis of a time period taken for the remaining level of the buffer to change from an ordinal remaining level value to the upper limit or the lower limit, an amount of expected deviation from an appropriate value for a frequency of the clock signal in this time period, and the clock control section controls the frequency of the clock signal so as to reduce the amount of the expected deviation.

4. The audio output device according to claim 3, wherein:
in a case where the remaining level of the buffer reaches the upper limit of the given range, the clock control section makes the frequency of the clock signal higher by a given adjustment amount, and, thereafter, at a time that the remaining level of the buffer changes back to the ordinal remaining level value, the clock control section controls the frequency of the clock signal as to reduce the amount of the expected deviation; and
in a case where the remaining level of the buffer reaches the lower limit of the given range, the clock control section makes the frequency of the clock signal lower by a given adjustment amount, and, thereafter, at a time that the remaining level of the buffer changes back to the ordinal remaining level value, the clock control section controls the frequency of the clock signal so as to reduce the amount of the expected deviation.

5. The audio output device according to claim 4, wherein:
in a case where the remaining level of the buffer reaches the upper limit of the given range, the clock control section makes the frequency of the clock signal higher by a given adjustment amount, and, thereafter, at a time that the remaining level of the buffer changes back to the ordinal remaining level value, the clock control section makes the frequency of the clock signal higher, by a value obtained by reducing the amount of the expected deviation by a given proportion, than a frequency of the clock signal observed at a timing immediately before the remaining level of the buffer reaches the upper limit of the given range; and
in a case where the remaining level of the buffer reaches the lower limit of the given range, the clock control section makes the frequency of the clock signal lower by a given adjustment amount, and, thereafter, at a time that the remaining level of the buffer changes back to the ordinal remaining level value, the clock control section makes the frequency of the clock signal lower, by a value obtained by reducing the amount of the expected deviation by a given proportion, than a frequency of the clock signal observed at a timing immediately before the remaining level of the buffer reaches the lower limit of the given range.

6. The audio output device according to claim 1, wherein:
the audio transmitting device is a radio processing device which processes a high frequency signal transmitted or received by an antenna; and
the audio output device further comprises a radio processing device control section which controls operation of the radio processing device.

7. The audio output device according to claim 1, further comprising:
a radio signal processing section which processes a high frequency signal transmitted or received by an antenna, wherein
the audio transmitting device is a controller which controls operation of the audio output device serving as a radio processing device.

8. A method for controlling an audio output device which is communicably connected with an audio transmitting device transmitting audio data, which receives the audio data from the audio transmitting device, and which outputs audio according to the audio data, the method comprising:
a communication step of receiving the audio data from the audio transmitting device;
an audio processing step of obtaining the audio data from a buffer in which the audio data received in the communication step is temporarily stored and carrying out an audio process with respect to the audio data so as to output audio; and
a clock control step of controlling, according to a remaining level of the buffer, a frequency of a clock signal specifying operation of the audio processing step.
